(19) United States
(12) Patent Application Publication
(10) Pub. No.: US 2004/0015453 A1
(43) Pub. Date: Jan. 22, 2004

(54) System and methods of an automated postal center

(76) Inventors: Steven Youngblood, Vienna, VA (US); Omar Dajani, Fairfax, VA (US); Gary Kanner, Annapolis, MD (US); Robert Czerwinski, Dulles, VA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/363,737

(22) PCT Filed: Sep. 7, 2001
(86) PCT No.: PCT/US01/27685

(51) Int. Cl. G06F 17/00

(52) U.S. Cl. 705/410

(57) ABSTRACT

Methods and apparatus are disclosed for processing a request by a user for postal service at an automated postal terminal. The method includes displaying on the terminal a list of services offered at the terminal. The list of services offered includes preparing postal information for mailing an item, purchasing postal payment indicia, and accessing information. The terminal receives a service selection and displays a payment amount, when payment is required for the selected service. The terminal receives the requested service by the terminal.

### RELATED APPLICATIONS

This application claims the benefit of a provisional application entitled “Systems and Methods of An Automated Postal Center,” filed Sep. 8, 2000 and assigned Ser. No. 60/231,170. The contents of the above application is relied upon and expressly incorporated herein by reference.

### DESCRIPTION OF THE INVENTION

Field of the Invention

This invention relates to providing postal services. More specifically, this invention relates to an automated postal terminal for providing postal services.

Background of the Invention

There are currently numerous automated terminals for performing a variety of functions. The most common automated terminal is the automatic teller machine, or ATM. There are also automated terminals for selling airline tickets, movie tickets, and other types of tickets, as well as vending machines for selling stamps. However, there are no integrated automated terminals for providing postal services, including selling stamps, preparing a package for mailing, updating postal databases, and providing postal or government information.

It is therefore desirable to provide methods and apparatus for automatically supplying a wider variety of postal services.

### SUMMARY OF THE INVENTION

An embodiment of the invention provides a method for processing a request by a user for postal service at an automated postal terminal. The method includes displaying on the terminal a list of services offered at the terminal. The list of services offered includes preparing postal information for mailing an item, purchasing postal payment indicia, and accessing information. The terminal receives a service selection and displays a payment amount, when payment is required for the selected service. The terminal receives payment by the terminal after display of payment amount, and after receipt of payment provides the requested service by the terminal.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and, together with the description, serve to explain the advantages and principles of the invention.

FIG. 1 illustrates an embodiment of an automated postal terminal.

FIG. 2 is a block diagram of the hardware of an automated postal terminal.

FIG. 3 is a flow diagram of a method for receiving service requests.

FIG. 4 is a flow diagram of a method of providing the service of purchasing postal payment indicia.

FIG. 5 is a flow diagram of a method of providing the service of providing postal information for mailing an item.

FIG. 6 illustrates information available when accessing information.

FIG. 7 is a flow diagram of a method for providing zip code lookup.

FIG. 8 is a flow diagram of a method of providing the service of holding mail.

FIG. 9 is a flow diagram of a method of providing the service of address change.

FIG. 10 illustrates a method for monitoring the operation of a terminal.

### DESCRIPTION OF THE EMBODIMENTS

Reference will now be made in detail to the embodiments consistent with the invention. Wherever possible, the same reference numbers will be used throughout the drawings to refer to the same or like parts.

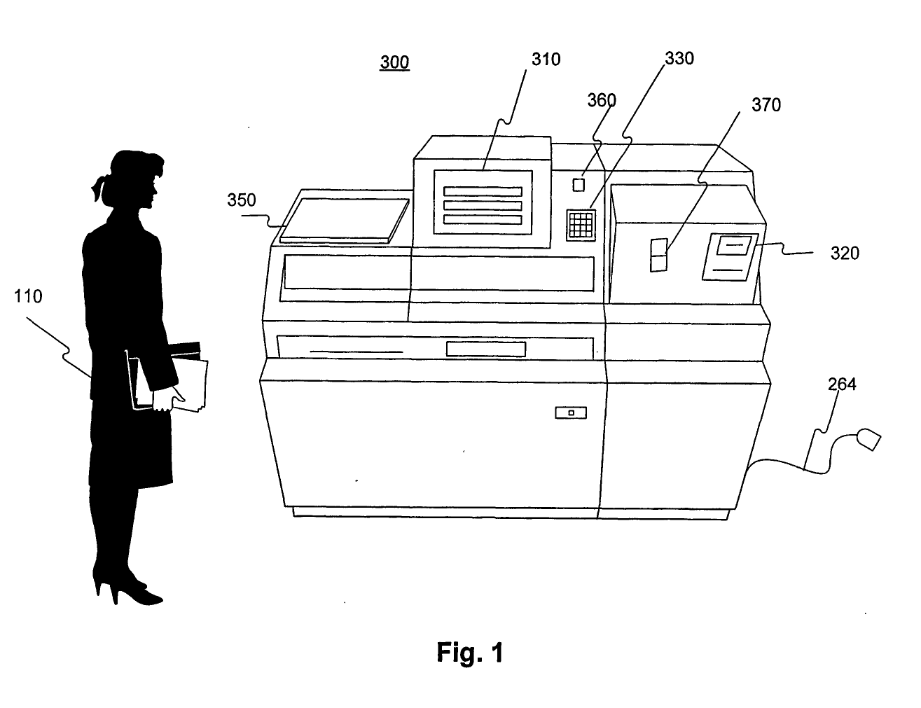

FIG. 1 shows an automated terminal 300 for providing postal services, consistent with the invention. As shown in FIG. 1, a user 110 may access terminal 300 to obtain postal services. In this embodiment, terminal 300 is a freestanding terminal, but other embodiments such as a wall-mounted terminal are possible.

Terminal 300 is a reliable, interactive, expandable and flexible system capable of providing both current and future postal services. It may be configured to provide users with a broad range of selected postal products and services, financial services, government information, and other offerings, while maximizing convenience to a user. It is flexible so that it can be configured to offer different services at different installation sites.

Terminal 300 includes a display 310 for displaying a list of services offered at the terminal. Display 310 can be a touch screen, such as a 14-inch LCD color display with a glass panel that uses Surface Acoustic Wave (SAW) or other technology to detect touch input on its surface. Display 310 can be used to list the services offered by the terminal, including, for example, preparing postal information for mailing an item, purchasing postal payment indicia, and accessing information. Although display 310 is used to receive a service selection in terminal 300, a keypad, buttons, or other input devices can be used to receive a service selection. Display 310 can also be used to display a payment amount when payment is required for a selected service. A service, such as purchasing stamps or postal payment indicia, may require a user provide a payment amount.

The payment amount, such as a US dollar or other currency value, can be received though a payment receiver 320. Payment receiver 320 may be a cash payment receiver, such as a Toyocom BV 5101US bill validator, a coin changer, such as the Nagler N702, or a credit/debit card reader. Receiver 320 may also include a chip card station, to read and write to “smart cards.” In association with a card reader or chip card station, an encrypting keypad 330 can be used for secure entry of debit card PINs.

Terminal 300 may include a network connection 264 to banking verification services to permit verification of payment by user 110. Network connection 264 may also provide access to various databases, to be described below. Terminal 300 may also provide a receipt to user 110 by way of a visual indicator on display 310, an electronic message sent to an electronic account, or a receipt printed by a receipt printer 370. Receipt printer 370 may be a Swecoin T-080 direct thermal printer.

Terminal 300 may also include a scale 350 to weigh an item for shipment. Scale 350 may be, for example, a Weigh-Tronix model 7623K. The weight information determined by scale 350 may be displayed on display 310 or on a separate display not shown.

Display 310 may list a series of delivery options offered at the terminal. Delivery options may include express mail, priority mail, certified mail, return receipt, delivery conformation, or any other postal mailing service offered by the USPS such as first class mail. Through display 310 or some other input means user 110 may select a delivery option. Based on the weight and the delivery option, terminal 300 can calculate the shipping cost and supply postage payment indicia in the appropriate amount. The postage payment indicia may constitute postage stamps or printed adhesive indicia The postage stamps may be supplied to user 110 by way of a stamp dispenser or stamp sheetlet dispenser, such as a Toyocom DS-20-2. Printed adhesive indicia may be created using a variable rate stamp printer, such as Neopost PC Stamp Postage Secure Device using a Practical Automation cLTX direct thermal printer or a Pitney Bowes postage meter.

For certain delivery options, such as certified mail or express mail, terminal 300 can print the postage delivery paperwork forms necessary for mailing. These forms can be printed using a Lexmark Optra S 1625 laser printer. Terminal 300 may capture an image of user 110 using a camera 360, such as a Sony XC-999 CCD color camera

For the purchase of postal payment indicia, terminal 300 may display on display 310 a selection of stamps or printed postal payment indicia offered. A user may make a selection through display 310 or another input medium. Terminal 300 may prepare postal payment indicia by accessing stamp sheetlets, stamp booklets, or individual stamps, or by printing a specific postal value on printed adhesive paper indicia, such as a bar coded or metered indicia The postal payment indicia may be provided through an outlet on terminal 300.

For accessing information, terminal 300 may display on display 310 a selection of available information. The information may include postal service information, such as speed and cost of mailing to different locations, zip codes associated with street addresses, proof of delivery, or postal service security. Offered information may also include information from government agencies, such as the Internal Revenue Service (“IRS”) and the Department of Housing and Urban Development (“HUD”). The information accessed on terminal 300 may be stored locally in terminal 300, or it may be accessed though network connection 264, and may be displayed on display 310 or on a separate display, not shown. In other applications, the information provided may be provided in printed form, audio form generated through a speaker, or electronic for via an email message sent to an electronic account.

Terminal 300 may offer other services, including holding mail and changing an address. Through display 310, user 110 may enter an address and holding time. This information is then transferred over network connection 264 and entered into a postal database at a remote location in order to perform a mail hold service. For change of address service, user 110 may enter an old address and a new address via display 310. This information is then transferred over network connection 264 and entered into a remote postal database in order to perform a change mail service. In alternate embodiments, entered information, for mail hold and change of address service could be stored locally and transferred to the database at regular intervals for entry and updating.

Terminal 300 may provide terminal status information, for maintenance purposes, to a remote terminal monitoring system. This information may include the status of major systems of terminal 300, such as network connection 264; devices on the system; user interaction; stamp, paper, and forms supply; power supply; access door state; or alarm state.

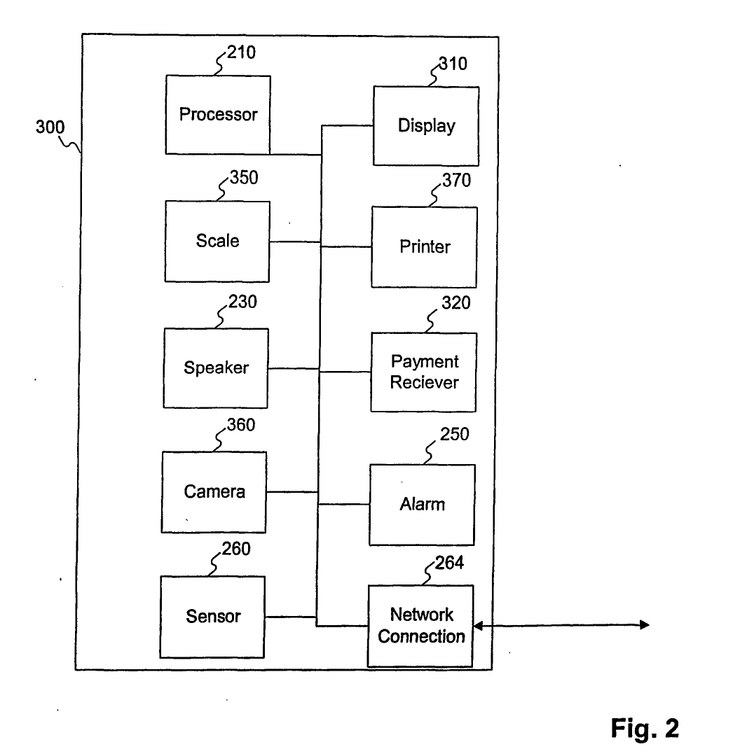

FIG. 2 is a block diagram of the hardware components of one embodiment of an automated postal terminal. Hardware components used to support one embodiment of terminal 300 include a processor 210, display 310, scale 350, printer 370, a speaker 230, payment receiver 320, camera 360, an alarm 250, a proximity sensor 260, and network connection 264. Processor 210, such as a Pentium II processor, is connected to all of the components of terminal 300. Alarm 250 may be an internal alarm system that is connected to speaker 230 to provide a loud audible alarm when armed. Sensor 260 may be a motion detector to detect when a user is near the terminal. Network connection 264 may connect terminal 300 to a remote monitoring system, to banking centers, to a vending activity reporting system, to a retail data mart or to other services, such as financial accounting system or postal information database.

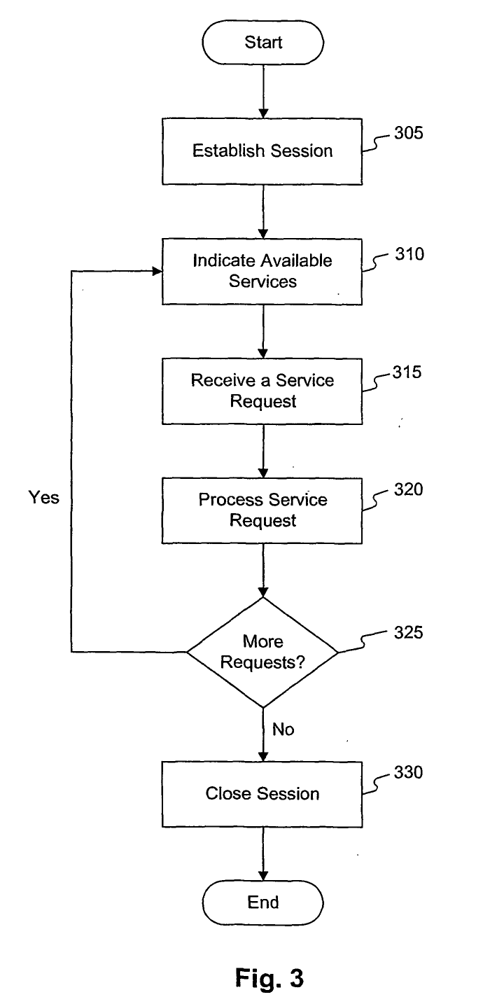

FIG. 3 is a flow diagram of a method for receiving service requests at a terminal. First, the terminal establishes a session (stage 305). This takes place when a user approaches the terminal and performs and action such as touching touch screen display 310 (FIG. 1) or coming within the range of sensor 260 (FIG. 2). Next, the terminal displays the services available at terminal 300 (FIG. 1) for a user to request (stage 310). Different terminals may have different configurations providing differing levels of service availability. One embodiment of a terminal may allow for access to all potential services. Another embodiment of a terminal may allow for access to only those services that do not require payment or billing. Yet another embodiment of a terminal may allow for access to any combination of services offered.

Next, the terminal receives a user request for service (stage 315). Once the terminal receives the request, the request is processed (stage 320). Once processed, the computer will ask if the user has completed their use of the terminal or if the user wishes to request more services (stage 325). If the user wishes to make more requests the computer returns to the available services menu. Otherwise, the computer closes the session (stage 330) and the use of the terminal is complete.

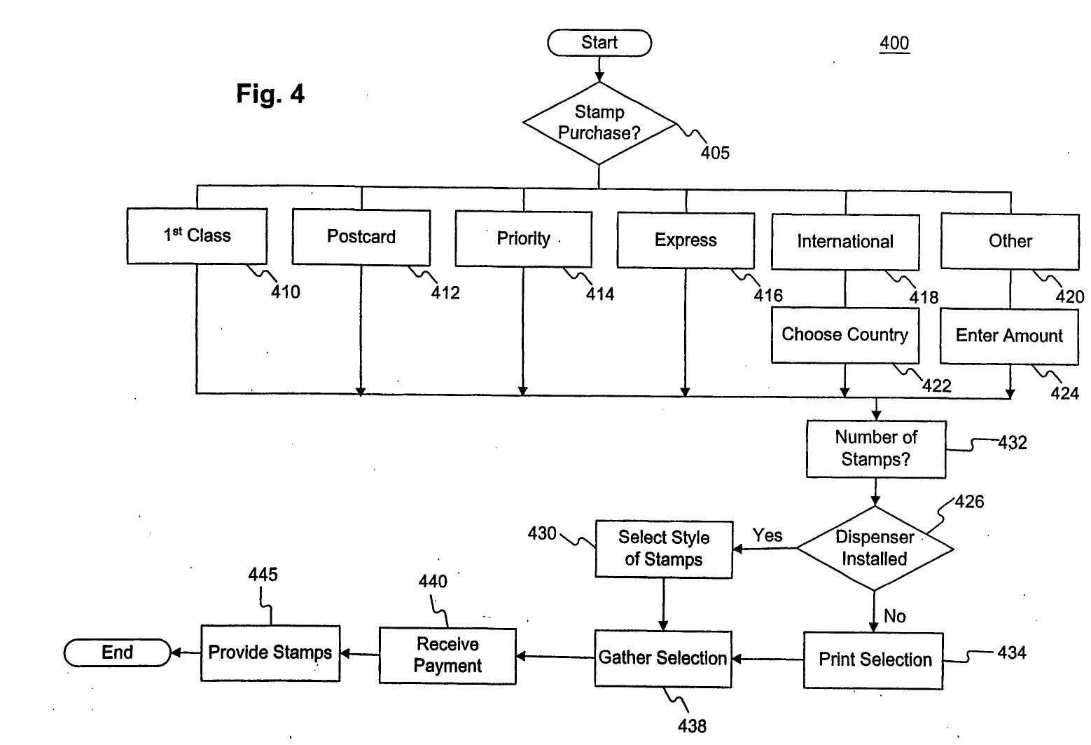

FIG. 4 is a flow diagram of the method of providing the service of purchasing postal payment indicia, such as a stamp. First the user is requested to indicate what type of service they would like to purchase (stage 405). The choices may include first class (stage 410), postcard (stage 412), priority (stage 414), express (stage 416), international (stage 418), or other (stage 420). For the international choice, the user must indicate the desired country to access the appropriate rate for that country (sep 422). For the other choice, the user must indicate the specific amount for the postal payment indicia to be purchased (stage 424).

The customer is then requested to indicate the number of indicia to be purchased (stage 432). The terminal determines if a stamp dispenser is installed for the product requested (stage 426). If a dispenser is not installed, an adhesive indicia in the appropriate amount is printed (stage 434). If a dispenser is installed, the user is requested to select the style of stamp the user wishes to receive (stage 430). The terminal then gathers the selection (stage 438), and requests and receives payment for the product (stage 440). Once payment is received and verified, the terminal provides the product to the user (stage 445).

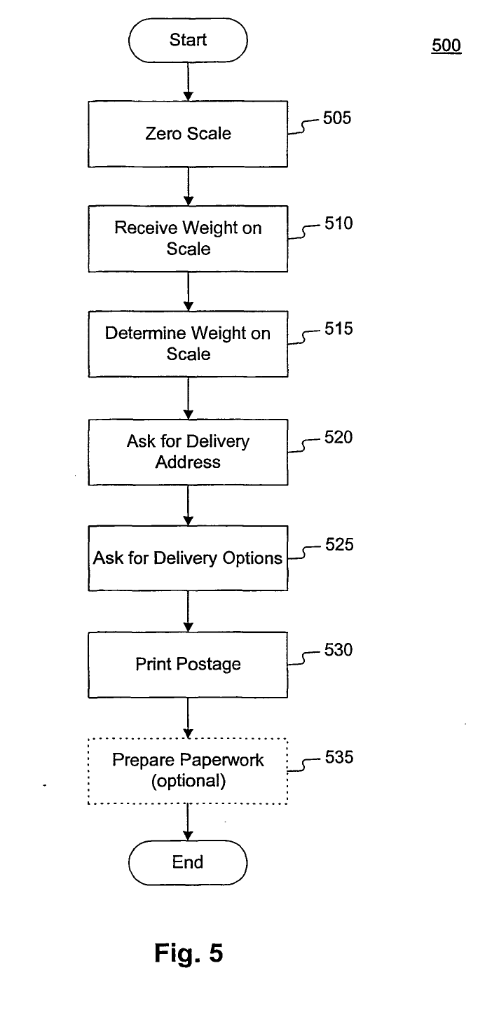

FIG. 5 is a flow diagram of a method of providing postal information for mailing an item. The item may be a letter, a package, a parcel, or any type of mail piece that a user desires to send through the postal system. First, the terminal zeros the scale (stage 505). Next, the terminal receives the item on scale 350 (FIG. 1) (stage 510) and determines the weight of the item (stage 515). The terminal then requests a delivery address (stage 520) and a delivery option (stage 525). The delivery options may include type of delivery, such as priority, express or first class, and value-added services such as insurance, delivery confirmation, or return receipt. The terminal prints the appropriate postage for the item (stage 530). The terminal then optionally prepares other necessary paperwork (stage 535).

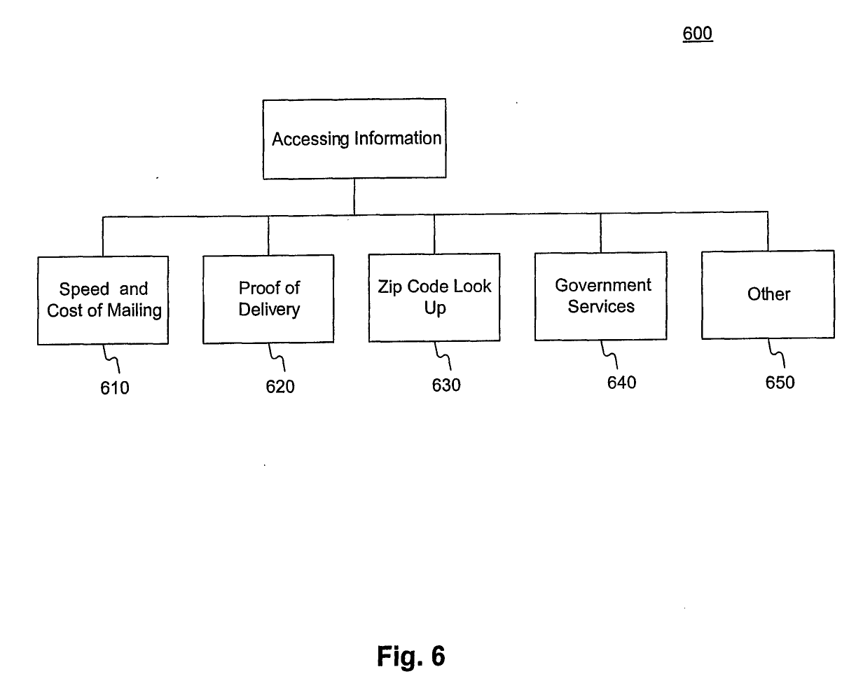

FIG. 6 illustrates an embodiment providing information access. Available information includes a listing of the speed and cost of mailing to different locations 610, information about proof of delivery 620, and zip code look up 630. A variety of government services 640, such as IRS forms and information or HUD information, can be accessed. Other services 650, such as other postal information services, may by included in certain embodiments.

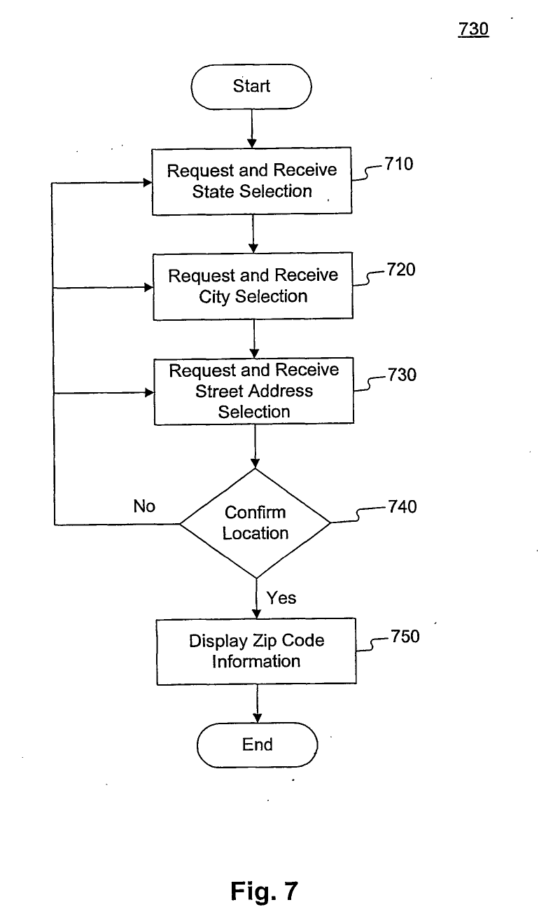

FIG. 7 is a flow diagram of one type of information access, namely, zip code lookup. The terminal first requests and receives a state selection (stage 710). Then, the terminal requests and receives a city selection (stage 720). At stage 730, the terminal requests and receives a street address (stage 730). The terminal then confirms the accuracy of the received location information (stage 740). If any part of the information is incorrect, then the terminal returns to an appropriate stage to request and receive correct information. If the location is correct, the terminal accesses a U.S. Postal Service database, either stored locally, or via a network connection, and displays the correct zip code to the user (stage 750).

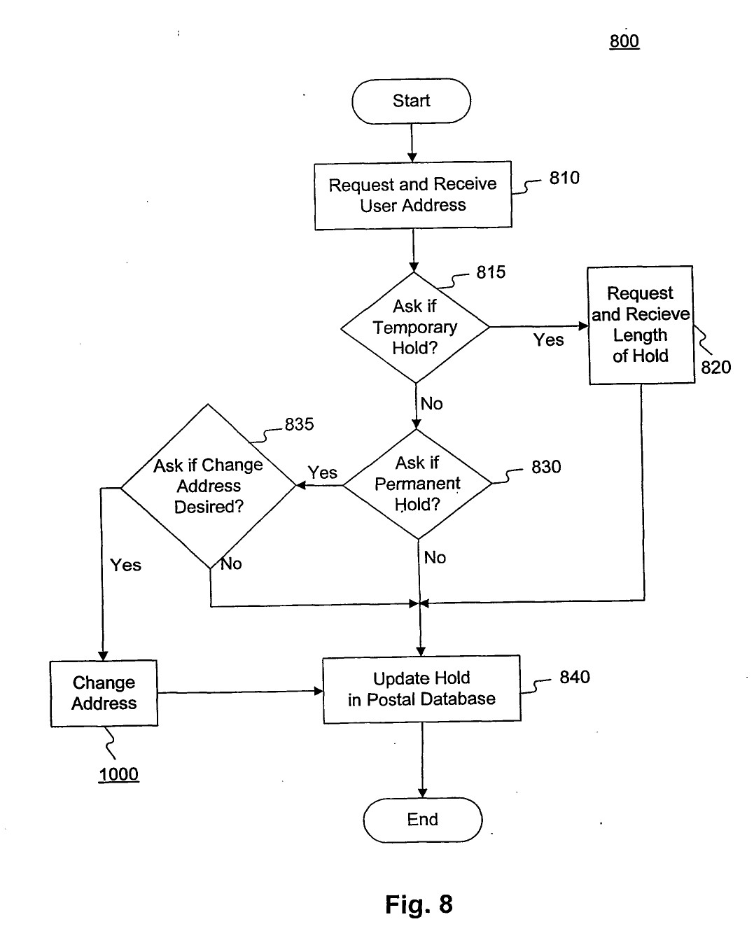

FIG. 8 is a flow diagram of a method of providing the service of holding mail. First, the system, requests and receives an address from a user (stage 810). Next, the system asks the user if it is a temporary change (stage 815). If the user responds that it is a temporary change, then the system receives from the user the length of time for the hold (stage 820). If it is not a temporary change then the system asks the user if it is a permanent hold (stage 830). If the user responds that it is a permanent hold, the system asks if the user wishes to change their address (stage 835). If the user responds that they would like to change their address, then a change of address process (900) is performed. For a temporary hold or a permanent hold with no address change, the hold is updated in the postal database (stage 840).

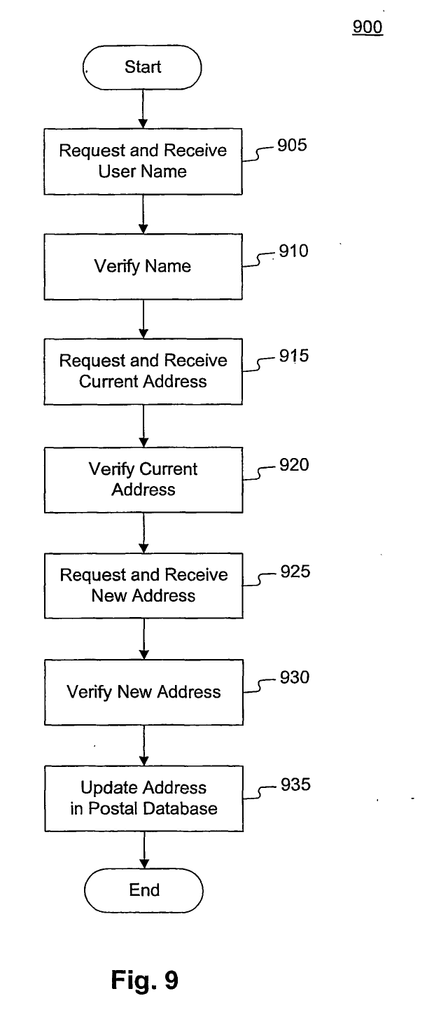

FIG. 9 is a flow diagram of a method of providing the service of address change, process 900. First, the terminal requests and receives a user name (stage 905) and verifies the name (stage 910). Then the terminal requests, receives, and verifies a current address (stage 915 and 920). The verification can take place either by asking the user if the information is correct, by checking the name and address information in a postal service database, or both. Then the terminal requests, receives, and verifies a new address (stage 925 and 930). At this point, the terminal updates the address in the postal database (stage 935) via network connection 264.

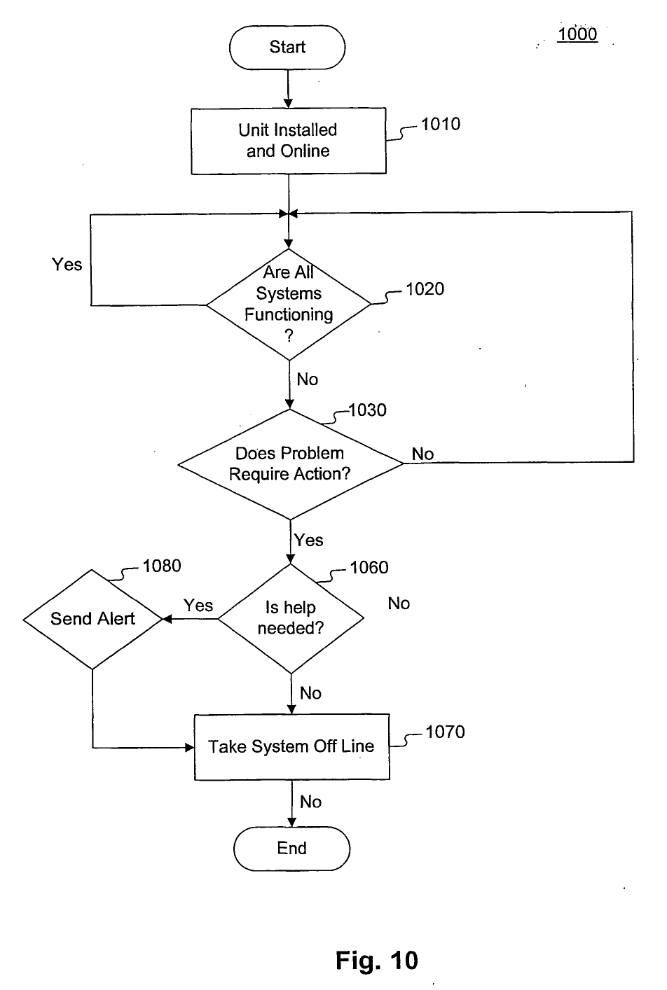

FIG. 10 illustrates a method for monitoring the operation of a terminal. The method may be implemented as part of a three-tier monitoring system, in which a remote computer serves as the first tier and remotely monitors the terminal. The second tier involves using a remotely located “help desk” to work through any problems detected by the first tier. The third tier comprises a contracted outside vendor to provide detailed support.

Once a terminal is installed, it connects to and goes online with a terminal monitoring system (stage 1010) via network connection 264 (FIG. 1). The terminal monitoring system continuously monitors the terminal to verify that all terminal systems are functioning (stage 1020). The terminal systems that are monitored by the terminal monitoring system may include communication capability, the input/output devices, processor, status of user interaction, power supplies, access door status, and alarm status. If all terminal systems are properly functioning, then the terminal monitoring system will continue to verify the functioning status of the system. If there is a problem, then the system determines if the problem requires corrective action (stage 1030). If no action is required the method returns to step 1020. If the problem does require immediate action, then the terminal monitoring system determines if help is needed to fix the terminal system (stage 1060). If not, then the terminal is taken offline (stage 1070) until further steps are determined. If help is needed then an alert can be sent out (stage 1080), before taking the terminal offline (stage 1070).

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for processing a request by a user for postal service at an automated postal terminal, comprising:
displaying on the terminal a list of services offered at the terminal, the list including at least:
preparing postal information for mailing an item;
purchasing postal payment indicia; and
accessing information;
receiving a service selection at the terminal;
displaying a payment amount when payment is required for the selected service;
receiving payment by the terminal after display of payment amount; and
providing the requested service by the terminal.

2. The method of claim 1, wherein:
receiving a service selection comprises receiving a request to prepare postal information for mailing an item; and
providing the requested service comprises:
determining the weight of the item on a scale at the terminal;
displaying on the terminal a list of delivery options offered at the terminal;
receiving a delivery option selection at the terminal; and
providing postage payment indicia for the item in accordance with the determined weight and selected delivery option.

3. The method of claim 2, wherein providing the requested service further comprises:
printing postal delivery paperwork for a selected delivery option.

4. The method of claim 2, wherein providing the requested service further comprises:
capturing an image of the user at the terminal.

5. The method of claim 1, wherein:
receiving a service selection comprises receiving a request to purchase postal payment indicia; and
providing the requested service comprises:
displaying on the terminal a list of postal payment indicia offered;
receiving a selection of postal payment indicia at the terminal;
preparing the selected postal payment indicia at the terminal; and
providing the selected postal payment indicia at the terminal.

6. The method of claim 1, wherein:
receiving a service selection comprises receiving a request to access information; and
providing the requested service comprises:
displaying on the terminal a list of information available;
receiving an information selection at the terminal;
supplying the selected information at the terminal.

7. The method of claim 1, wherein the services offered further comprise:
holding mail; and
changing an address.

8. The method of claim 7, wherein:
receiving a service selection comprises receiving a request to hold mail; and
providing the requested service comprises:
receiving at the terminal current address information;
receiving at the terminal a length of time for a hold; and
updating a postal database to reflect the current address and length of time through a network connection.

9. The method of claim 7, wherein:
receiving a service selection comprises receiving a request to change an address; and
providing the requested service comprises:
receiving at the terminal current address information;
receiving at the terminal new address information; and
updating a postal database to reflect the new address through a network connection.

10. The method of claim 1 further comprising:
providing a receipt by the terminal.

11. The method of claim 1 further comprising:
verifying the payment by the terminal through a network connection.

12. The method of claim 1 further comprising:
transmitting status reports to a remote terminal manager through a network connection.

13. An automated postal terminal apparatus for processing a request by a user for postal service, comprising:
a display providing a list of services offered at the terminal, the list including at least:
providing postal information for mailing an item;
purchasing postal payment indicia; and
accessing information;
a selection device for receiving a service selection;
a payment receiver for receiving payment;
a network connection; and
a processor connected to the display, selection device, payment receiver and network connection for controlling the operation of the terminal.
